(19) United States
(12) Patent Application Publication
(10) Pub. No.: US 2018/0359775 A1
(43) Pub. Date: Dec. 13, 2018

(54) METHOD FOR PERFORMING RLC RETRANSMISSION BASED ON UL GRANT IN WIRELESS COMMUNICATION SYSTEM AND A DEVICE THEREFOR

(71) Applicant: LG ELECTRONICS INC., Seoul (KR)

(72) Inventors: Seungjune YI, Seoul (KR); Sunyoung LEE, Seoul (KR)

(73) Assignee: LG ELECTRONICS INC., Seoul (KR)

(21) Appl. No.: 15/778,194

(22) PCT Filed: Nov. 16, 2016
(86) PCT No.: PCT/KR2016/013215

§ 371 Date: May 22, 2018

Related U.S. Application Data
(60) Provisional application No. 62/269,050, filed on Dec. 17, 2015.

(51) Int. Cl. H04W 72/14; H04L 1/18

(52) U.S. Cl. CPC H04W 72/14; H04L 1/1812

(57) ABSTRACT

The present invention relates to a wireless communication system. More specifically, the present invention relates to a method and a device for performing RLC retransmission based on UL grant in wireless communication system, the method comprising: transmitting a MAC PDU including at least one RLC PDU received from a corresponding RLC entity on a HARQ process; receiving an UL grant for the HARQ process; considering that the at least one RLC PDU in the MAC PDU transmission is successful if the UL grant is for new transmission; and updating a value of RLC window for the corresponding RLC entity.

### TECHNICAL FIELD

The present invention relates to a wireless communication system and, more particularly, to a method for performing RLC retransmission based on UL grant in wireless communication system and a device therefor.

### BACKGROUND ART

As an example of a mobile communication system to which the present invention is applicable, a 3rd Generation Partnership Project Long Term Evolution (hereinafter, referred to as LTE) communication system is described in brief.

FIG. 1 is a view schematically illustrating a network structure of an E-UMTS as an exemplary radio communication system. An Evolved Universal Mobile Telecommunications System (E-UMTS) is an advanced version of a conventional Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARQ)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

Although wireless communication technology has been developed to LTE based on wideband code division multiple access (WCDMA), the demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

### DISCLOSURE

### Technical Problem

An object of the present invention devised to solve the problem lies in a method and device for performing RLC retransmission based on UL grant in wireless communication system.

The technical problems solved by the present invention are not limited to the above technical problems and those skilled in the art may understand other technical problems from the following description.

### Technical Solution

The object of the present invention can be achieved by providing a method for User Equipment (UE) operating in a wireless communication system as set forth in the appended claims.

In another aspect of the present invention, provided herein is a communication apparatus as set forth in the appended claims.

It is to be understood that both the foregoing general description and the following detailed description of the present invention are exemplary and explanatory and are intended to provide further explanation of the invention as claimed.

### Advantageous Effects

In this invention, the UE considers reception of a RLC status report including Acknowledgement (ACK) for the at least one RLC PDU from the eNB if the UL grant is for new transmission, and the UE updates a value of RLC window for the corresponding RLC entity instead of retransmission of the RLC PDU without any RLC status report. .

It will be appreciated by persons skilled in the art that the effects achieved by the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a diagram showing a network structure of an Evolved Universal Mobile Telecommunications System (E-UMTS) as an example of a wireless communication system;

FIG. 2A is a block diagram illustrating network structure of an evolved universal mobile telecommunication system (E-UMTS), and FIG. 2B is a block diagram depicting architecture of a typical E-UTRAN and a typical EPC;

FIG. 3 is a diagram showing a control plane and a user plane of a radio interface protocol between a UE and an E-UTRAN based on a 3rd generation partnership project (3GPP) radio access network standard;

FIG. 4 is a view showing an example of a physical channel structure used in an E-UMTS system;

FIG. 5 is a block diagram of a communication apparatus according to an embodiment of the present invention;

FIG. 6A is an example for data transmission and reception for a Category 0 low complexity UE, FIG. 6B is an example for repetitions for data transmission for a Category 0 low complexity UE.

FIG. 7 is a conceptual diagram for an RLC (Radio Link Control) entity architecture;

FIG. 8 is a conceptual diagram for an AM RLC (Acknowledged mode Radio Link Control) entity architecture;

FIG. 9 is a conceptual diagram for an RLC (Radio Link Control) status PDU (Protocol Data Unit) structure;

FIG. 10 is a conceptual diagram for performing RLC retransmission based on UL grant in wireless communication system according to embodiments of the present invention; and

FIGS. 11 and 12 are examples for performing RLC retransmission based on UL grant in wireless communication system according to embodiments of the present invention.

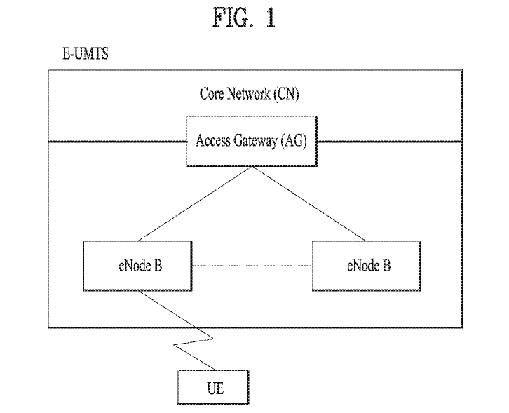

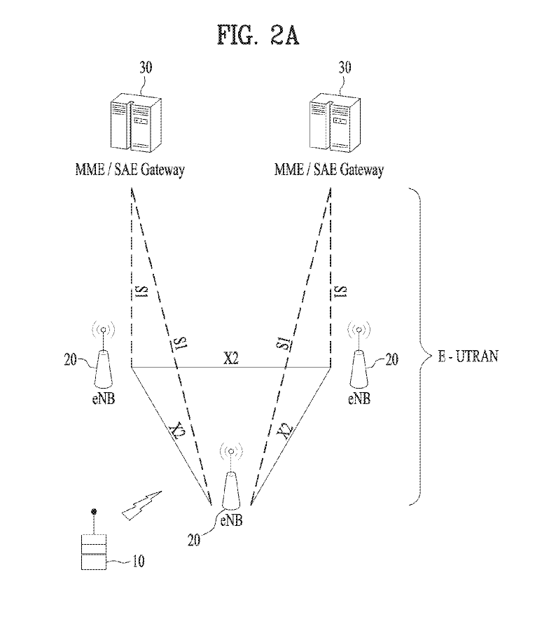

### BEST MODE

Universal mobile telecommunications system (UMTS) is a 3rd Generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3G LTE requires reduced cost per bit, increased service availability, flexible use of a frequency band, a simple structure, an open interface, and adequate power consumption of a terminal as an upper-level requirement.

Hereinafter, structures, operations, and other features of the present invention will be readily understood from the embodiments of the present invention, examples of which are illustrated in the accompanying drawings. Embodiments described later are examples in which technical features of the present invention are applied to a 3GPP system.

Although the embodiments of the present invention are described using a long term evolution (LTE) system and a LTE-advanced (LTE-A) system in the present specification, they are purely exemplary. Therefore, the embodiments of the present invention are applicable to any other communication system corresponding to the above definition. In addition, although the embodiments of the present invention are described based on a frequency division duplex (FDD) scheme in the present specification, the embodiments of the present invention may be easily modified and applied to a half-duplex FDD (H-FDD) scheme or a time division duplex (TDD) scheme.

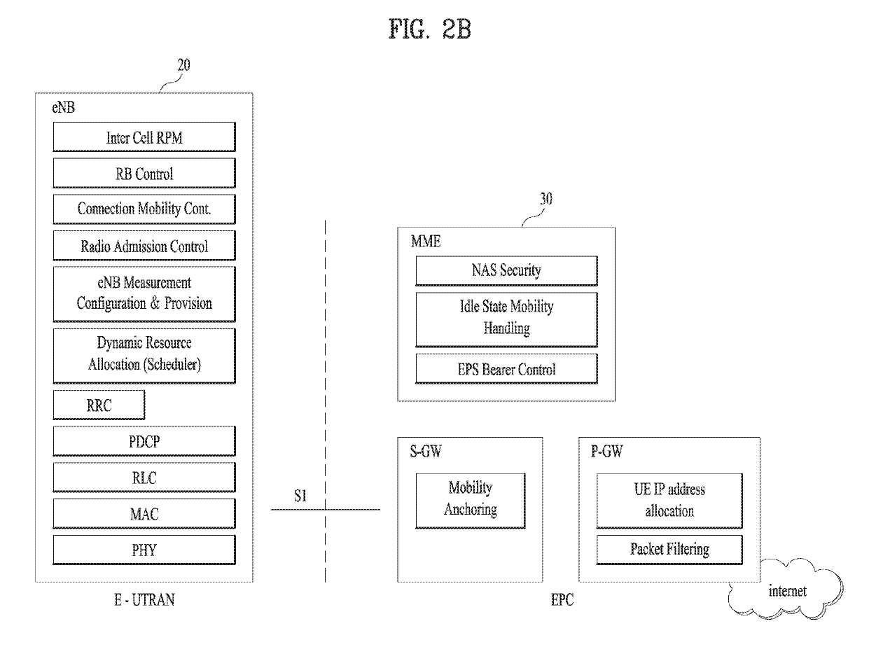

FIG. 2A is a block diagram illustrating network structure of an evolved universal mobile telecommunication system (E-UMTS). The E-UMTS may be also referred to as an LTE system. The communication network is widely deployed to provide a variety of communication services such as voice (VoIP) through IMS and packet data.

As illustrated in FIG. 2A, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from eNodeB 20 to UE 10, and “uplink” refers to communication from the UE to an eNodeB. UE 10 refers to communication equipment carried by a user and may be also referred to as a mobile station (MS), a user terminal (UT), a subscriber station (SS) or a wireless device.

FIG. 2B is a block diagram depicting architecture of a typical E-UTRAN and a typical EPC.

As illustrated in FIG. 2B, an eNodeB 20 provides end points of a user plane and a control plane to the UE 10. MME/SAE gateway 30 provides an end point of a session and mobility management function for UE 10. The eNodeB and MME/SAE gateway may be connected via an S1 interface.

The eNodeB 20 is generally a fixed station that communicates with a UE 10, and may also be referred to as a base station (BS) or an access point. One eNodeB 20 may be deployed per cell. An interface for transmitting user traffic or control traffic may be used between eNodeBs 20.

The MME provides various functions including NAS signaling to eNodeBs 20, NAS signaling security, AS Security control, Inter CN node signaling for mobility between 3GPP access networks, Idle mode UE Reachability (including control and execution of paging retransmission), Tracking Area list management (for UE in idle and active mode), PDN GW and Serving GW selection, MME selection for handovers with MME change, SGSN selection for handovers to 2G or 3G 3GPP access networks, Roaming, Authentication, Bearer management functions including dedicated bearer establishment, Support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity includes both an MME and an SAE gateway.

A plurality of nodes may be connected between eNodeB 20 and gateway 30 via the S1 interface. The eNodeBs 20 may be connected to each other via an X2 interface and neighboring eNodeBs may have a meshed network structure that has the X2 interface.

As illustrated, eNodeB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNodeB measurements, radio bearer control, radio admission control (RAC), and connection mobility control in LTE ACTIVE state. In the EPC, and as noted above, gateway 30 may perform functions of paging origination, LTE-IDLE state management, ciphering of the user plane, System Architecture Evolution (SAE) bearer control, and ciphering and integrity protection of Non-Access Stratum (NAS) signaling.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

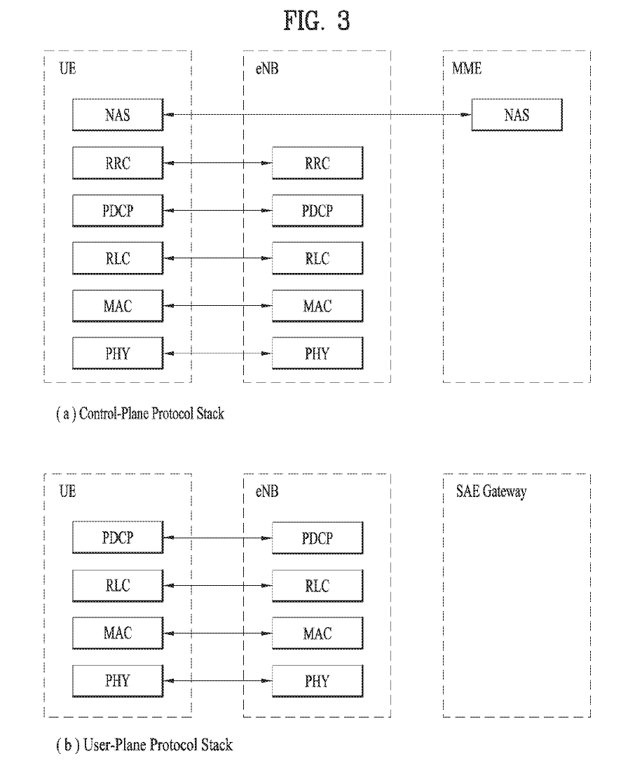

FIG. 3 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

A physical (PHY) layer of a first layer provides an information transfer service to a higher layer using a physical channel. The PHY layer is connected to a medium access control (MAC) layer located on the higher layer via a transport channel. Data is transported between the MAC layer and the PHY layer via the transport channel. Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

The MAC layer of a second layer provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

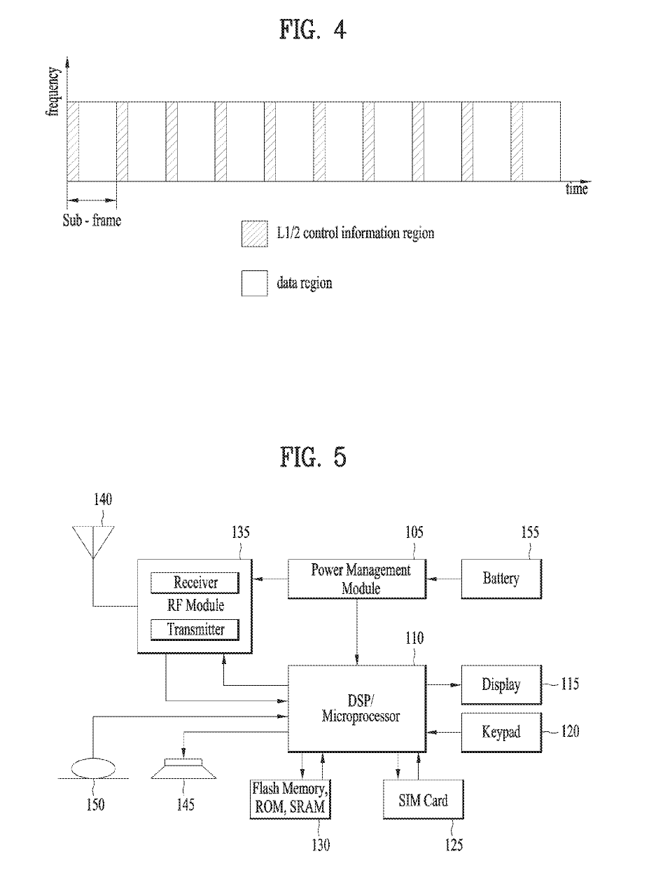

FIG. 4 is a view showing an example of a physical channel structure used in an E-UMTS system. A physical channel includes several subframes on a time axis and several subcarriers on a frequency axis. Here, one subframe includes a plurality of symbols on the time axis. One subframe includes a plurality of resource blocks and one resource block includes a plurality of symbols and a plurality of subcarriers. In addition, each subframe may use certain subcarriers of certain symbols (e.g., a first symbol) of a subframe for a physical downlink control channel (PDCCH), that is, an L1/L2 control channel. In FIG. 4, an L1/L2 control information transmission area (PDCCH) and a data area (PDSCH) are shown. In one embodiment, a radio frame of 10 ms is used and one radio frame includes 10 subframes. In addition, one subframe includes two consecutive slots. The length of one slot may be 0.5 ms. In addition, one subframe includes a plurality of OFDM symbols and a portion (e.g., a first symbol) of the plurality of OFDM symbols may be used for transmitting the L1/L2 control information. A transmission time interval (TTI) which is a unit time for transmitting data is 1 ms.

A base station and a UE mostly transmit/receive data via a PDSCH, which is a physical channel, using a DL-SCH which is a transmission channel, except a certain control signal or certain service data. Information indicating to which UE (one or a plurality of UEs) PDSCH data is transmitted and how the UE receive and decode PDSCH data is transmitted in a state of being included in the PDCCH.

For example, in one embodiment, a certain PDCCH is CRC-masked with a radio network temporary identity (RNTI) “A” and information about data is transmitted using a radio resource “B” (e.g., a frequency location) and transmission format information “C” (e.g., a transmission block size, modulation, coding information or the like) via a certain subframe. Then, one or more UEs located in a cell monitor the PDCCH using its RNTI information. And, a specific UE with RNTI “A” reads the PDCCH and then receive the PDSCH indicated by B and C in the PDCCH information.

FIG. 5 is a block diagram of a communication apparatus according to an embodiment of the present invention.

The apparatus shown in FIG. 5 can be a user equipment (UE) and/or eNB adapted to perform the above mechanism, but it can be any apparatus for performing the same operation.

As shown in FIG. 5, the apparatus may comprises a DSP/microprocessor (110) and RF module (transmiceiver; 135). The DSP/microprocessor (110) is electrically connected with the transciver (135) and controls it. The apparatus may further include power management module (105), battery (155), display (115), keypad (120), SIM card (125), memory device (130), speaker (145) and input device (150), based on its implementation and designer□s choice.

Specifically, FIG. 5 may represent a UE comprising a receiver (135) configured to receive a request message from a network, and a transmitter (135) configured to transmit the transmission or reception timing information to the network. These receiver and the transmitter can constitute the transceiver (135). The UE further comprises a processor (110) connected to the transceiver (135: receiver and transmitter).

Also, FIG. 5 may represent a network apparatus comprising a transmitter (135) configured to transmit a request message to a UE and a receiver (135) configured to receive the transmission or reception timing information from the UE. These transmitter and receiver may constitute the transceiver (135). The network further comprises a processor (110) connected to the transmitter and the receiver. This processor (110) may be configured to calculate latency based on the transmission or reception timing information.

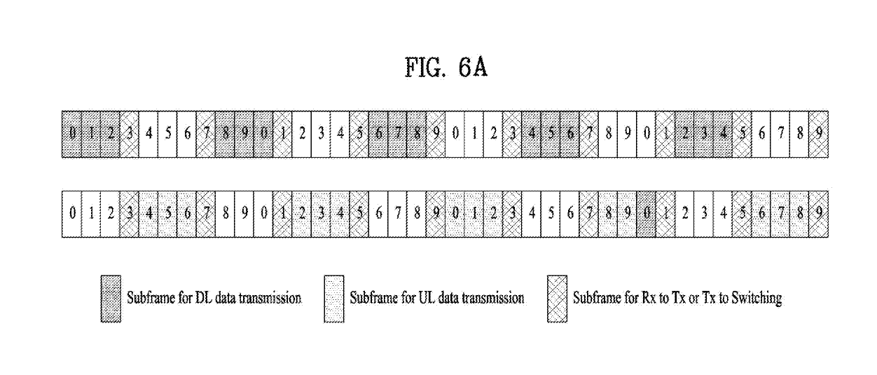

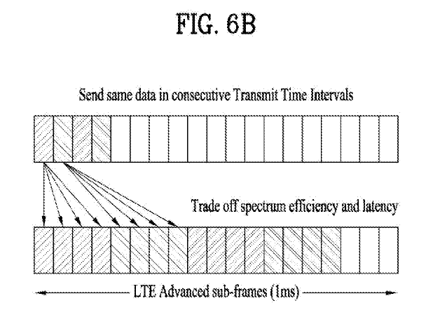

FIG. 6A is an example for data transmission and reception for a Category 0 low complexity UE, and FIG. 6B is an example for repetitions for data transmission for a Category 0 low complexity UE.

Such a communication technology as MTC is specialized from 3GPP to transmit and receive IoT-based information and the MTC has a difference according to each release of the technology. Release 10 and Release 11 are focusing on a method of controlling loads of IoT (M2M) products and a method of making the loads have least influence on a network when the IoT products make a request for accessing an eNB at the same time. Release 12 and Release 13 are focusing on a low-cost technology enabling a battery to be simply implemented and very little used by reducing complicated functions mounted on a legacy smartphone as many as possible.

Low complexity UEs are targeted to low-end (e.g. low average revenue per user, low data rate, delay tolerant) applications, e.g. some Machine-Type Communications.

A low complexity UE has reduced Tx and Rx capabilities compared to other UE of different categories.

In particular, a low complexity UE does not require such a function of high performance as a function of a smartphone and an amount of data used by the low complexity UE is not that big in general. Hence, there is no reason for a complicated and high-price communication module to come to the market for such a UE as the low complexity UE.

In order to manufacture a low-cost IoT (M2M) device, a concept such as UE Category 0 has been introduced. A UE category corresponds to a general figure used in 3GPP to indicate the amount of data capable of being processed by a UE in a communication modem. In general, as the amount of data to be processed is getting bigger, a price of a modem is also increasing due to a memory or performance enhancement. In case of a currently commercialized smartphone, performance of the smartphone is continuously increasing from 100 Mbps to 150 Mbps and 300 Mbps on the basis of download.

Table 1 shows UE categories used in 3GPP.

TABLE 1

| | | |
|---|---|---|
| UE | Downlink | Uplink |
| Category | (velocity) | (velocity) |

| | | | | |
|---|---|---|---|---|
| 0 | 1 | Mbps | 1 | Mbps |
| 1 | 10 | Mbps | 5 | Mbps |
| 2 | 50 | Mbps | 25 | Mbps |
| 3 | 100 | Mbps | 50 | Mbps |
| 4 | 150 | Mbps | 50 | Mbps |
| 5 | 300 | Mbps | 75 | Mbps |
| 6 | 300 | Mbps | 50 | Mbps |
| 7 | 300 | Mbps | 100 | Mbps |
| 8 | 3 | Gbps | 1.5 | Gbp |
| 9 | 450 | Mbps | 50 | Mbps |
| 10 | 450 | Mbps | 100 | Mbps |
| 11 | 600 | Mbps | 50 | Mbps |
| 12 | 600 | Mbps | 100 | Mbps |
| 13 | 400 | Mbps | 50 | Mbps |

A Category 0 low complexity UE may access a cell only if SIB1 indicates that access of Category 0 UEs is supported. If the cell does not support access of Category 0 UEs, the UE considers the cell as barred.

The eNB determines that a UE is a Category 0 UE based on the LCID for CCCH and the UE capability.

The S1 signalling has been extended to include the UE Radio Capability for paging. This paging specific capability information is provided by the eNB to the MME, and the MME uses this information to indicate to the eNB that the paging request from the MME concerns a low complexity UE.

And, since it is able to perform transmission and reception on specific time only without performing transmission and reception at the same time like FIG. 6A, it may be able to perform an operation of TDD in FDD (since transmission and reception are not performed at the same time). Additionally, unlike legacy TDD, since it is able to provide sufficient switching time as much as 1 ms to a section at which switching is performed between transmission and reception, it is able to expect a revolutionary cost reduction effect in terms of overall hardware part especially a modem and an RF. On the contrary, according to a regulation of a legacy LTE UE, it is mandatory to use at least 2 or more reception antennas.

NB-IoT provides access to network services using physical layer optimized for very low power consumption (e.g. full carrier bandwidth is 180 kHz, subcarrier spacing can be 3.75 kHz or 15 kHz).

As indicated in the relevant subclauses in this specification, a number of E-UTRA protocol functions supported by all Rel-8 UEs are not used for NB-IoT and need not be supported by eNBs and UEs only using NB-IoT. For NB-IoT, the narrowband physical downlink control channel (NPDCCH) is located in available symbols of configured subframes. Within a PRB pair, two control channel elements are defined, with each control channel element composed of resources within a subframe. NPDCCH supports aggregations of 1 and 2 control channel elements and repetition. NPDCCH supports C-RNTI, Temporary C-RNTI, P-RNTI, and RA-RNTI.

For NB-IoT, Asynchronous adaptive HARQ is supported, and RLC UM is not supported.

In particular, discussion on a solution for a performance deterioration problem caused by decrease of output power is in progress by considering a scheme of performing repetitive transmission as shown in FIB. 6B or a TTI bundling technology previously used in VoLTE (Voice of LTE, LTE voice call service). Consequently, it might say that it is able to develop a communication module of low complexity through the low-cost IoT (M2M) technology explained in the Release 12 and the low-power IoT (M2M) technology to which the Release 13 is targeting.

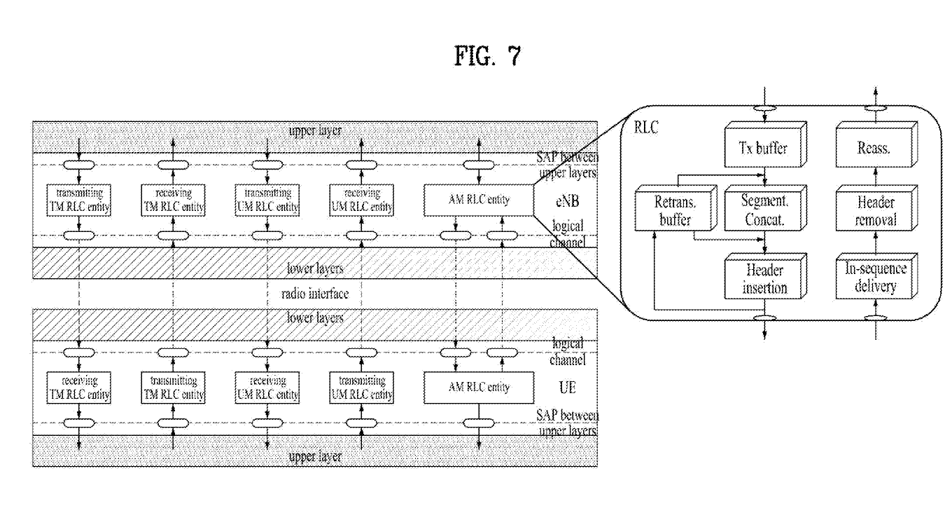

FIG. 7 is a conceptual diagram for an RLC (Radio Link Control) entity architecture.

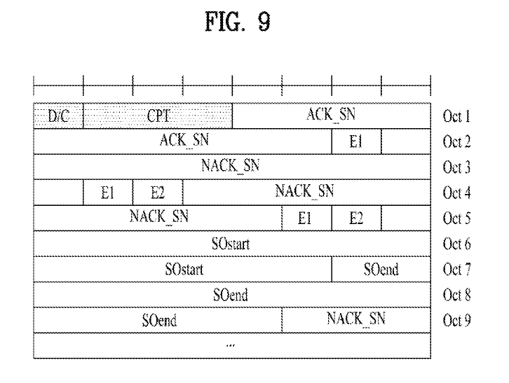

The radio-link control (RLC) protocol takes data in the form of RLC SDUs from PDCP and delivers them to the corresponding RLC entity in the receiver by using functionality in MAC and physical layers. The relation between RLC and MAC, including multiplexing of multiple logical channels into a single transport channel, is illustrated in FIG. 9. Multiplexing of several logical channels into a single transport channel is mainly used for priority handling in conjunction with downlink and uplink scheduling.

There is one RLC entity per logical channel configured for a terminal, where each RLC entity is responsible for: i) segmentation, concatenation, and reassembly of RLC SDUs; ii) RLC retransmission; and iii) in-sequence delivery and duplicate detection for the corresponding logical channel.

Other noteworthy features of the RLC are: (1) the handling of varying PDU sizes; and (2) the possibility for close interaction between the hybrid-ARQ and RLC protocols. Finally, the fact that there is one RLC entity per logical channel and one hybrid-ARQ entity per component carrier implies that one RLC entity may interact with multiple hybrid-ARQ entities in the case of carrier aggregation.

Segmentation, Concatenation, and Reassembly of RLC SDUs (Service Data Units)

The purpose of the segmentation and concatenation mechanism is to generate RLC PDUs of appropriate size from the incoming RLC SDUs. One possibility would be to define a fixed PDU size, a size that would result in a compromise. If the size were too large, it would not be possible to support the lowest data rates. Also, excessive padding would be required in some scenarios. A single small PDU size, however, would result in a high overhead from the header included with each PDU. To avoid these drawbacks, which is especially important given the very large dynamic range of data rates supported by LTE, the RLC PDU size varies dynamically.

In process of segmentation and concatenation of RLC SDUs into RLC PDUs, a header includes, among other fields, a sequence number, which is used by the reordering and retransmission mechanisms. The reassembly function at the receiver side performs the reverse operation to reassemble the SDUs from the received PDUs.

RLC Retransmission: retransmission of missing PDUs is one of the main functionalities of the RLC. Although most of the errors can be handled by the hybrid-ARQ protocol, there are benefits of having a second-level retransmission mechanism as a complement. By inspecting the sequence numbers of the received PDUs, missing PDUs can be detected and a retransmission requested from the transmitting side.

Different services have different requirements; for some services (for example, transfer of a large file), error-free delivery of data is important, whereas for other applications (for example, streaming services), a small amount of missing packets is not a problem. The RLC can therefore operate in three different modes, depending on the requirements from the application:

Transparent mode (TM) is completely transparent and is essentially bypassed. No retransmissions, no segmentation/reassembly, and no in-sequence delivery take place. This configuration is used for control-plane broadcast channels such as BCCH (Broadcast Control Channel), CCCH (Common Control Channel), and PCCH (Paging Control Channel), where the information should reach multiple users. The size of these messages are selected such that all intended terminals are reached with a high probability and hence there is neither need for segmentation to handle varying channel conditions, nor retransmissions to provide error-free data transmission. Furthermore, retransmissions are not possible for these channels as there is no possibility for the terminal to feedback status reports as no uplink has been established.

Unacknowledged mode (UM) supports segmentation/reassembly and in-sequence delivery, but not retransmissions. This mode is used when error-free delivery is not required, for example voiceover IP, or when retransmissions cannot be requested, for example broadcast transmissions on MTCH (Multicast Traffic Channel) and MCCH (Multicast Control Channel) using MBSFN (Multicast/Broadcast over a Single Frequency Network).

Acknowledged mode (AM) is the main mode of operation for TCP/IP packet data transmission on the DL-SCH (Downlink-Shared Channel). Segmentation/reassembly, in-sequence delivery, and retransmissions of erroneous data are all supported.

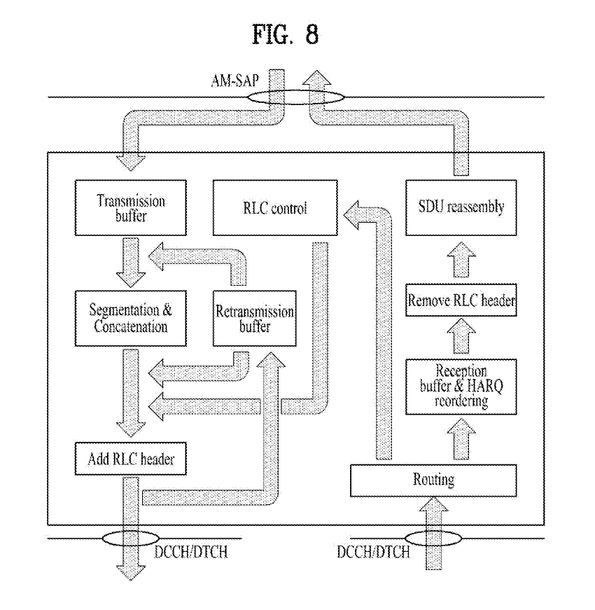

FIG. 8 is a conceptual diagram for an AM RLC (Acknowledged mode Radio Link Control) entity architecture.

In acknowledged mode (AM), the RLC entity is bidirectional-that is, data may flow in both directions between the two peer entities. This is obviously needed as the reception of PDUs needs to be acknowledged back to the entity that transmitted those PDUs. Information about missing PDUs is provided by the receiving end to the transmitting end in the form of so-called status reports. Status reports can either be transmitted autonomously by the receiver or requested by the transmitter. To keep track of the PDUs in transit, the transmitter attaches an RLC header to each PDU, including, among other fields, a sequence number.

Both RLC entities maintain two windows, the transmission and reception windows respectively. Only PDUs in the transmission window are eligible for transmission; PDUs with sequence number below the start of the window have already been acknowledged by the receiving RLC. Similarly, the receiver only accepts PDUs with sequence numbers within the reception window. The receiver also discards any duplicate PDUs as each PDU should be assembled into an SDU only once.

Status reports can, as mentioned earlier, be triggered for multiple reasons. However, to control the amount of status reports and to avoid flooding the return link with an excessive number of status reports, it is possible to use a status prohibit timer. With such a timer, status reports cannot be transmitted more often than once per time interval as determined by the timer.

For the initial transmission, it is relatively straightforward to rely on a dynamic PDU size as a means to handle the varying data rates. However, the channel conditions and the amount of resources may also change between RLC retransmissions. To handle these variations, already transmitted PDUs can be (re)segmented for retransmissions. The reordering and retransmission mechanisms described above still apply; a PDU is assumed to be received when all the segments have been received. Status reports and retransmissions operate on individual segments; only the missing segment of a PDU needs to be retransmitted.

FIG. 9 is a conceptual diagram for an RLC status PDU structure.

An RLC status PDU is used by the receiving side of an AM RLC entity to inform the peer AM RLC entity about RLC data PDUs that are received successfully, and RLC data PDUs that are detected to be lost by the receiving side of an AM RLC entity.

The RLC status PDU consists of a STATUS PDU payload and a RLC control PDU header. RLC control PDU header consists of a D/C and a CPT field. The STATUS PDU payload starts from the first bit following the RLC control PDU header, and it consists of one ACK_SN and one E1, zero or more sets of a NACK_SN, an E1 and an E2, and possibly a set of a SOstart and a SOend for each NACK SN. When necessary one to seven padding bits are included in the end of the STATUS PDU to achieve octet alignment.

There are various fields in the RLC status PDU structure.
Data/Control (DC) field: The D/C field indicates whether the RLC PDU is a RLC data PDU or RLC control PDU. The interpretation of the D/C field is provided in Table 2.

TABLE 2
D/C field interpretation

| Value | Description |
|---|---|
| 0 | Control PDU |
| 1 | Data PDU |

Control PDU Type (CPT) field: The CPT field indicates the type of the RLC control PDU. The interpretation of the CPT field is provided in Table 3.

TABLE 3
CPT field interpretation

| Value | Description |
|---|---|
| 000 | STATUS PDU |
| 001-111 | Reserved (PDUs with this coding will be discarded by the |
| | receiving entity for this release of the protocol |

Acknowledgement SN (ACK_SN) field: The ACK_SN field indicates the SN of the next not received RLC Data PDU which is not reported as missing in the STATUS PDU. When the transmitting side of an AM RLC entity receives a STATUS PDU, it interprets that all AMD PDUs up to but not including the AMD PDU with SN=ACK_SN have been received by its peer AM RLC entity, excluding those AMD PDUs indicated in the STATUS PDU with NACK_SN and portions of AMD PDUs indicated in the STATUS PDU with NACK_SN, SOstart and SOend.
Extension bit 1 (E1) field: The E1 field indicates whether or not a set of NACK_SN, E1 and E2 follows. The interpretation of the E1 field is provided in Table 4.

TABLE 4
E1 field interpretation

| Value | Description |
|---|---|
| 0 | A set of NACK_SN, E1 and E2 dose not follow. |
| 1 | A set of NACK_SN, E1 and E2 follows. |

Negative Acknowledgement SN (NACK_SN) field: The NACK_SN field indicates the SN of the AMD PDU (or portions of it) that has been detected as lost at the receiving side of the AM RLC entity.
Extension bit 2 (E2) field: The E2 field indicates whether or not a set of SOstart and SOend follows. The interpretation of the E2 field is provided in Table 5.

TABLE 5
E2 field interpretation

| Value | Description |
|---|---|
| 0 | A set of SOstart and SOend does not follow for this NACK_SN. |
| 1 | A set of SOstart and SOend follow for this NACK_SN. |

SO start (SOstart) field: The SOstart field (together with the SOend field) indicates the portion of the AMD PDU with SN=NACK_SN (the NACK_SN for which the SOstart is related to) that has been detected as lost at the receiving side of the AM RLC entity. Specifically, the SOstart field indicates the position of the first byte of the portion of the AMD PDU in bytes within the Data field of the AMD PDU. The first byte in the Data field of the original AMD PDU is referred by the SOstart field value “000000000000000”, i.e., numbering starts at zero.
SO end (SOend) field: The SOend field (together with the SOstart field) indicates the portion of the AMD PDU with SN=NACK_SN (the NACK_SN for which the SOend is related to) that has been detected as lost at the receiving side of the AM RLC entity. Specifically, the SOend field indicates the position of the last byte of the portion of the AMD PDU in bytes within the Data field of the AMD PDU. The first byte in the Data field of the original AMD PDU is referred by the SOend field value “000000000000000”, i.e., numbering starts at zero. The special SOend value “111111111111111” is used to indicate that the missing portion of the AMD PDU includes all bytes to the last byte of the AMD PDU.
Reserved 1 (R1) field (NOT described): The R1 field is a reserved field for this release of the protocol. The transmitting entity shall set the R1 field to “0”. The receiving entity shall ignore this field.

In MAC, after performing the maximum number of retransmission, the HARQ process flushes its HARQ buffer, i.e. discards the MAC PDU stored in the HARQ buffer, so that the HARQ buffer becomes empty. After that, if the MAC entity receives an UL grant for that HARQ process of which the buffer is empty, the UE performs a new transmission by obtaining a MAC PDU from the ‘Multiplexing and Assembly’ entity.

In RLC, i) a transmitting side of an AM RLC entity retransmits a RLC data PDU (i.e. AMD PDU or AMD PDU segment) only if the RLC data PDU is NACKed via the RLC STATUS PDU, and ii) a transmitting side of an AM RLC entity updates the transmission window when the first in-sequence AMD PDU (i.e. VT(A)) is ACKed via the RLC STATUS PDU.

As the retransmission and window update are based on RLC STATUS PDU, the fast transmission in RLC layer requires frequent transmission of RLC STATUS PDU. However, transmitting RLC STATUS PDU itself requires radio resource, and the frequent transmission of RLC STATUS PDU causes large signaling overhead. Moreover, the UE has to monitor PDCCH to receive RLC STATUS PDU, which brings power consumption.

In NB-IOT, it is important to have a lighter protocol so that the NB-IOT UE can save power consumption with reduced signaling overhead. In this sense, RLC retransmission may need to be re-designed in a simpler way, e.g., by getting rid of or minimizing transmission of RLC STATUS PDU.

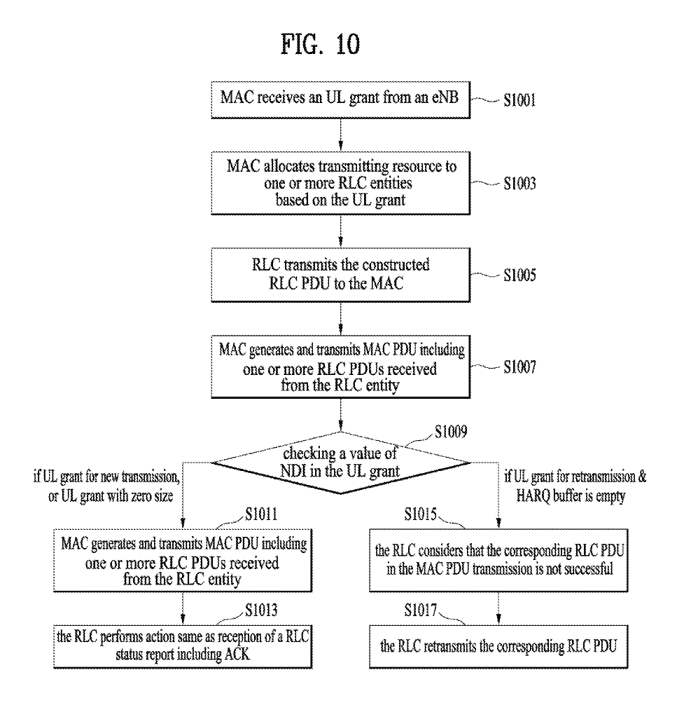

FIG. 10 is a conceptual diagram for performing RLC retransmission based on UL grant in wireless communication system according to embodiments of the present invention.

In this invention, an RLC entity performs retransmission of an RLC data PDU (i.e. TMD PDU, UMD PDU, AMD PDU, or AMD PDU segment) if a MAC PDU containing the RLC data PDU was flushed from a HARQ process and a MAC entity receives an UL grant for the HARQ process with a NDI value same as the last used value.

If the NDI value in the received UL grant is toggled compared to the last used NDI value for the HARQ process, the RLC entity considers that the transmission of the RLC PDUs is successful, and updates the transmission window.

The invention may apply only to the UL grant with non-zero size uplink resource. If the UE receives an UL grant with zero size uplink resource, the RLC entity considers that the transmission of the RLC PDUs is successful, regardless of NDI value of the received UL grant.

When the MAC entity receives an UL grant from an eNB (S1001), the MAC entity allocates transmitting resource to one or more RLC entities having data available for transmission considering the size of MAC Control Elements to be transmitted (S1003).

When the RLC entity receives transmitting resource from the MAC entity, the RLC entity constructs one or more RLC PDUs, the total size being less than or equal to the allocated transmitting resource. The RLC PDU is one of the following forms: RLC data PDU (i.e., TMD PDU, UMD PDU, AMD PDU or AMD PDU segment), or RLC control PDU (i.e., RLC STATUS PDU).

The RLC entity transmits the constructed RLC PDU to the MAC entity (S1005). For the transmission priority, the RLC control PDU has higher priority than the RLC data PDU, and, among RLC data PDUs, retransmitting PDU has higher priority than newly transmitting PDU.

When the MAC entity receives one or more RLC PDUs from the RLC entity, the MAC entity constructs a MAC PDU including the one or more RLC PDUs received from the RLC entity, and potentially other RLC PDUs received from other RLC entities and MAC control elements, based on the Logical Channel Prioritization procedure.

The MAC entity stores the constructed MAC PDU in the HARQ buffer of the HARQ process indicated by the UL grant. The UL grant may include indicator of the HARQ process, or they are associated with time.

The MAC entity transmits the constructed MAC PDU to the eNB using the HARQ process (1007). The retransmission of the MAC PDU is performed in either an adaptive manner or a non-adaptive manner. For adaptive retransmission, the MAC entity performs retransmission only when UL grant for retransmission is received. On the other hand, for non-adaptive retransmission, the MAC entity performs retransmission using the UL grant received for initial transmission until HARQ ACK is received.

After performing above actions, if UL HARQ operation is synchronous the HARQ process then flushes its HARQ buffer if the number of retransmission reaches MaxTx. The number of retransmission of a MAC PDU within a HARQ process is limited to MaxTx, and it is configured by eNB.

If the MAC entity receives an UL grant for the HARQ process, the MAC entity checks the received UL grant (S1009).

If the UL grant is for new transmission, the RLC entity considers that the at least one RLC PDU in the MAC PDU transmission is successful (S1011).

Preferably, if the NDI value in the received UL grant is toggled compared to the last used NDI value for the HARQ process, the UE considers that the UL grant is for new transmission.

Preferably, if the NDI value in the received UL grant is toggled compared to the last used NDI value for the HARQ process, the MAC entity indicates to the RLC entity that the transmission of the RLC PDUs included in the MAC PDU is successful (Grant_ACK). The indication may include the identifier of the RLC PDUs included in the MAC PDU. Upon reception of the Grant_ACK from the MAC entity, the RLC entity considers that the transmission of the RLC PDUs is successful.

In this case, the UE performs action same as reception of a RLC status report including Acknowledgement (ACK) for the at least one RLC PDU from the eNB (S1013). For example, the UE updates the transmission window if the Grant_ACKed RLC data PDU is lower edge of the transmission window.

Preferably, the indication may include the identifier of the RLC PDUs included in the MAC PDU.

In addition, the invention may apply only to the UL grant with non-zero size uplink resource. If the UE receives an UL grant with zero size uplink resource, the RLC entity considers that the at least one RLC PDU in the MAC PDU transmission is successful regardless of NDI value of the received UL grant (S1011). In this case, the UE performs action same as reception of a RLC status report including Acknowledgement (ACK) for the at least one RLC PDU from the eNB (S1013). The UL grant with zero size may be used only at the end of data burst.

Preferably, the invention may apply only to AM RLC, i.e. the RLC supporting retransmission, and the invention may apply only to the UE with simplified protocols (e.g. NB-IOT UE), e.g. having only one DRB and only one HARQ process.

As mentioned above, if UL HARQ operation is synchronous the HARQ process then flushes its HARQ buffer if the number of retransmission reaches MaxTx.

If the MAC entity receives an UL grant for the HARQ process whose HARQ buffer has been flushed and is empty, the MAC entity checks the value of the New Data Indicator (NDI) included in the UL grant. The NDI is 1 bit field, having value of 0 or 1.

If the NDI value in the received UL grant is same as the last used NDI value for the HARQ process, the RLC entity considers that the at least one RLC PDU in the MAC PDU transmission is not successful (S1015).

More specifically, the MAC entity indicates to the RLC entity that the transmission of the RLC PDUs included in the MAC PDU flushed from the HARQ process is not successful (Grant_NACK) if a MAC PDU containing the RLC data PDU was flushed from a HARQ process and a MAC entity receives an UL grant for the HARQ process with a NDI value same as the last used value. Upon reception of the Grant_NACK from the MAC entity, the RLC entity considers that the transmission of the RLC PDUs is not successful, and prepares them for the retransmission (S1017). The RLC entity retransmits the Grant_NACKed RLC PDUs at the earliest transmission opportunity.

Preferably, the indication may include the identifier of the RLC PDUs included in the flushed MAC PDU.

Preferably, the invention may apply only to AM RLC, i.e. the RLC supporting retransmission.

The main point of this invention is for performing RLC retransmission without RLC status reporting. In the prior art, the RLC retransmission is performed only when the RLC status reporting indicating NACK signal is received from an eNB. However, according to this invention, the RLC retransmission can be performed based on UL grant before RLC status reporting is received. If the UE receives UL grant for new transmission, the UE considers reception of a RLC status report including Acknowledgement (ACK) for the at least one RLC PDU from the eNB, and if the UE receives UL grant for re-transmission and HARQ buffer is empty, the UE considers reception of a RLC status report including Negative_Acknowledgement (NACK) for the at least one RLC PDU from the eNB.

Because transmitting RLC STATUS PDU itself requires radio resource, and the frequent transmission of RLC STATUS PDU causes large signaling overhead, the invention can provide simpler way of RLC retransmission.

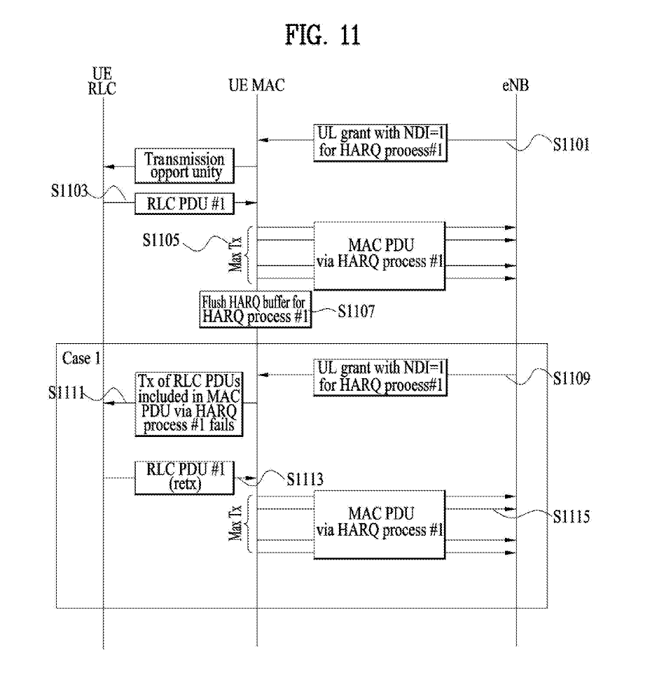

FIG. 11 is an example for performing RLC retransmission based on UL grant in wireless communication system according to embodiments of the present invention.

The UE receives an UL grant for HARQ process #1 with NDI=1 (S1101). The UE MAC indicates to the UE RLC the transmission opportunity. The UE RLC delivers the RLC PDUs to be transmitted to the UE MAC (S1103). The UE MAC generates a MAC PDU including the received RLC PDU #1.

The UE MAC transmits the generated MAC PDU to the eNB via HARQ process #1. The UE MAC performs transmission of MAC PDU up to MaxTx times (MAC HARQ) (S1105).

Upon reaching MaxTx times of transmissions, the UE MAC flushes the HARQ buffer for the HARQ process #1, i.e., discards the MAC PDU transmitted via HARQ process #1 (S1107).

The UE MAC receives an UL grant for HARQ process #1 with NDI=1 (S1109).

Since the NDI value in the received UL grant (=1) is the same as the last used NDI value for the HARQ process #1 (=1), the MAC entity indicates Grant NACK to the RLC entity that the transmission of the RLC PDU #1 included in the MAC PDU flushed from the HARQ process #1 is not successful (S1111).

Upon reception of the Grant NACK from the MAC entity, the RLC entity considers that the transmission of the RLC PDU #1 included in the MAC PDU transmitted via HARQ process #1 is not successful, and prepares RLC PDU #1 for the retransmission. The RLC entity retransmits the Grant_NACKed RLC PDUs at the earliest transmission opportunity (S1113).

The UE MAC generates the MAC PDU including the received RLC PDU #1 for retransmission, and performs HARQ transmission of the generated MAC PDU (S1115).

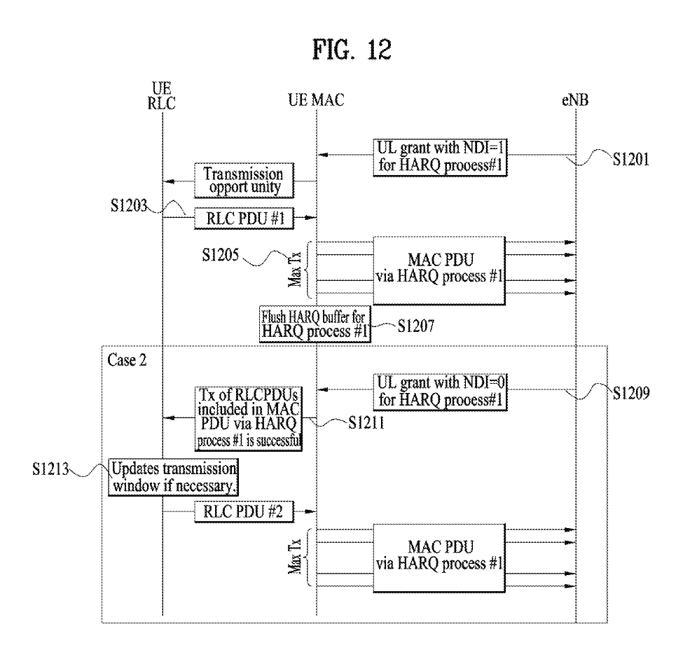

FIG. 12 is an example for performing RLC retransmission based on UL grant in wireless communication system according to embodiments of the present invention.

The UE receives an UL grant for HARQ process #1 with NDI=1 (S1201). The UE MAC indicates to the UE RLC the transmission opportunity. The UE RLC delivers the RLC PDU #1 to be transmitted to the UE MAC (S1203).

The UE MAC generates a MAC PDU including the received RLC PDU #1. The UE MAC transmits the generated MAC PDU to the eNB via HARQ process #1. The UE MAC performs transmission of MAC PDU up to MaxTx times (MAC HARQ) (S1205).

Upon reaching MaxTx times of transmissions, the UE MAC flushes the HARQ buffer for the HARQ process #1, i.e., discards the MAC PDU transmitted via HARQ process #1 (S1207).

The UE MAC receives an UL grant for HARQ process #1 with NDI=0 (S1209).

Since the NDI value in the received UL grant (=0) is toggled compared to the last used NDI value for the HARQ process #1 (=1), the MAC entity indicates Grant ACK to the RLC entity that the transmission of the RLC PDU #1 included in the MAC PDU flushed from the HARQ process #1 is successful (S1211).

Upon reception of the Grant_ACK from the MAC entity, the RLC entity considers that the transmission of the RLC PDU #1 included in the MAC PDU transmitted via HARQ process #1 is successful, and updates the transmission window if the Grant_ACKed RLC data PDU is lower edge of the transmission window (S1213).

The UE RLC delivers new RLC PDU #2 to the UE MAC. The UE MAC generates the MAC PDU including the received new RLC PDU #2, and performs HARQ transmission of the generated MAC PDU.

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by subsequent amendment after the application is filed.

In the embodiments of the present invention, a specific operation described as performed by the BS may be performed by an upper node of the BS. Namely, it is apparent that, in a network comprised of a plurality of network nodes including a BS, various operations performed for communication with an MS may be performed by the BS, or network nodes other than the BS. The term ‘eNB’ may be replaced with the term ‘fixed station’, ‘Node B’, ‘Base Station (BS)’, ‘access point’, etc.

The above-described embodiments may be implemented by various means, for example, by hardware, firmware, software, or a combination thereof.

In a hardware configuration, the method according to the embodiments of the present invention may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, or microprocessors.

In a firmware or software configuration, the method according to the embodiments of the present invention may be implemented in the form of modules, procedures, functions, etc. performing the above-described functions or operations. Software code may be stored in a memory unit and executed by a processor. The memory unit may be located at the interior or exterior of the processor and may transmit and receive data to and from the processor via various known means.

Those skilled in the art will appreciate that the present invention may be carried out in other specific ways than those set forth herein without departing from essential characteristics of the present invention. The above embodiments are therefore to be construed in all aspects as illustrative and not restrictive. The scope of the invention should be determined by the appended claims, not by the above description, and all changes coming within the meaning of the appended claims are intended to be embraced therein.

### INDUSTRIAL APPLICABILITY

While the above-described method has been described centering on an example applied to the 3GPP LTE system, the present invention is applicable to a variety of wireless communication systems in addition to the 3GPP LTE system.

What is claimed is:

1. A method for a User Equipment (UE) operating in a wireless communication system, the method comprising:
transmitting a Medium Access Control (MAC) Protocol Data Unit (PDU) including at least one Radio Link Control (RLC) PDU received from a corresponding RLC entity on a Hybrid-ARQ (HARQ) process;
receiving an uplink (UL) grant for the HARQ process;
considering that the at least one RLC PDU in the MAC PDU transmission is successful if the UL grant is for new transmission; and
updating a value of RLC window for the corresponding RLC entity.

2. The method according to claim 1, wherein if the UL grant is for new transmission, the UE considers reception of a RLC status report including Acknowledgement (ACK) for the at least one RLC PDU from the eNB.

3. The method according to claim 1, wherein if a New Data Indicator (NDI) value in the received UL grant is toggled compared to a last used NDI value for the HARQ process, the UE considers that the UL grant is for new transmission.

4. The method according to claim 1, wherein if the UL grant indicates that uplink resource is zero size, the UE considers that the at least one RLC PDU in the MAC PDU transmission is successful, even if a NDI value in the received UL grant is same as a last used NDI value for the HARQ process.

5. The method according to claim 1, further comprising:
considering that the at least one RLC PDU in the MAC PDU transmission is not successful if the UL grant is for re-transmission and a HARQ buffer corresponding to the
performing the at least one RLC PDU retransmission by the corresponding RLC entity.

6. The method according to claim 1, wherein the RLC entity of the UE is acknowledged mode (AM) RLC supporting retransmission.

7. The method according to claim 1, wherein the UE flushes the HARQ buffer when a number of retransmissions of the MAC PDU reaches a maximum number of retransmission of the MAC PDU.

8. A User Equipment (UE) for operating in a wireless communication system, the UE comprising:
a Radio Frequency (RF) module; and
a processor operably coupled with the RF module and configured to:
transmit a Medium Access Control (MAC) Protocol Data Unit (PDU) including at least one Radio Link Control (RLC) PDU received from a corresponding RLC entity on a Hybrid-ARQ (HARQ) process,
receive an uplink (UL) grant for the HARQ process,
consider that the at least one RLC PDU in the MAC PDU transmission is successful if the UL grant is for new transmission, and
update a value of RLC window for the corresponding RLC entity.

9. The UE according to claim 8, wherein if the UL grant is for new transmission, the processor considers reception of a RLC status report including Acknowledgement (ACK) for the at least one RLC PDU from the eNB.

10. The UE according to claim 8, wherein if a New Data Indicator (NDI) value in the received UL grant is toggled compared to a last used NDI value for the HARQ process, the processor considers that the UL grant is for new transmission.

11. The UE according to claim 8, wherein if the UL grant indicates that uplink resource is zero size, the processor considers that the at least one RLC PDU in the MAC PDU transmission is successful, even if a NDI value in the received UL grant is same as a last used NDI value for the HARQ process.

12. The UE according to claim 8, wherein the processor is further configured to:
consider that the at least one RLC PDU in the MAC PDU transmission is not successful if the UL grant is for re-transmission and a HARQ buffer corresponding to the HARQ process is empty, and
perform the at least one RLC PDU retransmission by the corresponding RLC entity.

13. The UE according to claim 8, wherein the RLC entity of the UE is acknowledged mode (AM) RLC supporting retransmission.

14. The UE according to claim 8, wherein the processor flushes the HARQ buffer when a number of retransmissions of the MAC PDU reaches a maximum number of retransmission of the MAC PDU.
